(19) United States
(12) Patent Application Publication
(10) Pub. No.: US 2014/0266040 A1
(43) Pub. Date: Sep. 18, 2014

(54) ELECTRIC VEHICLE SUPPLY EQUIPMENT HAVING INCREASED COMMUNICATION CAPABILITIES

(71) Applicant: TYCO ELECTRONICS CORPORATION, Berwyn, PA (US)

(72) Inventors: Mudhafar Hassan-Ali, Petaluma, CA (US); Jason Larson, San Lorenzo, CA (US); Matthew Anderson, San Mateo, CA (US)

(21) Appl. No.: 13/828,881

(22) Filed: Mar. 14, 2013

(51) Int. Cl. B60L 11/18

(52) U.S. Cl. CPC B60L 11/1816
USPC 320/109

(57) ABSTRACT

An electric vehicle support equipment (EVSE) system that includes a nozzle (122) configured to couple to an electric vehicle, the nozzle including a first microcontroller (MCU). The EVSE also includes a charging circuit interrupt device (CCID) configured to couple to a power source, the CCID including a second MCU and a cable that is coupled between the CCID and the nozzle. The CCID is configured to receive a pilot signal from the electric vehicle, the pilot signal conveying pilot information, and overlay additional information onto the pilot signal.

### BACKGROUND OF THE INVENTION

The subject matter herein relates to electric vehicle supply equipment having increased communication capabilities.

Electric vehicle supply equipment is used to enable an electric vehicle to be coupled to, or uncoupled from, a power supply. In operation, the electric vehicle supply equipment therefore enables the electric vehicle to be charged via power received from the power supply when in the coupled configuration and to be electrically uncoupled from the power supply in the uncoupled configuration.

Electric vehicle supply equipment generally includes a cable having a plug at one end that is configured to couple to the power supply. The cable also includes a nozzle at an opposite end that couples to the electric vehicle. The plug may be fabricated to comply with appropriate standards, such as the National Electrical Manufacturer's Association (NEMA). For example, the plug may be a NEMA-5 plug that couples to a standard outlet used in the United States. The plug may comply with standards set in other countries.

The nozzle may be fabricated to comply with appropriate standards, such as the Society of Automotive Engineers (SAE) J1772 standard, the IEC 61851-1, or other standards to enable the nozzle to be utilized with a variety of electric vehicles. The standards may outline various capabilities that should be provided by the nozzle. For example, the SAE J1772 standard states that the nozzle should include a plurality of conductors to enable a charging current to be transmitted from the power source to the electric vehicle. The SAE J1772 standard also states that the nozzle should enable a pilot signal to be transmitted from the electric vehicle to the charging unit. In operation, the pilot signal is used to coordinate a charging level between the electric vehicle and the charging unit. However, as electric vehicles and the charging units become more complex, there is an increased level of information that is desired to be transmitted between the electric vehicle and the charging unit.

A need therefore remains for a nozzle that is operable to transmit additional information between the electric vehicle and the charging unit while ensuring that the nozzle is still in compliance with the SAE J1772 standard.

### BRIEF DESCRIPTION OF THE INVENTION

In one embodiment, electric vehicle support equipment (EVSE) system is provided. The EVSE includes a nozzle configured to couple to an electric vehicle, the nozzle including a first microcontroller (MCU). The EVSE also includes a charging circuit interrupt device (CCID) configured to couple to a power source, the CCID including a second MCU and a cable that is coupled between the CCID and the nozzle. The CCID is configured to receive a pilot signal from the electric vehicle, the pilot signal conveying pilot information, and overlay additional information onto the pilot signal.

In another embodiment, a nozzle for coupling an electric vehicle to a power source is provided. The nozzle includes a microcontroller (MCU) configured to receive a pilot signal from the electric vehicle, the pilot signal conveying pilot information, and overlay additional information onto the pilot signal.

### BRIEF DESCRIPTION OF THE DRAWINGS

FIG. 1 illustrates electric vehicle supply equipment (EVSE) formed in accordance with an exemplary embodiment.

FIG. 2 is a schematic illustration of a plug formed in accordance with an exemplary embodiment.

FIG. 3 is a simplified block diagram of a portion of the EVSE shown in FIG. 1 in accordance with an exemplary embodiment.

FIG. 4 is a detailed block diagram of a portion of the EVSE shown in FIG. 3.

FIG. 5 is a pilot signal that may be generated in accordance with an exemplary embodiment.

FIGS. 6A and 6B are detailed schematic illustrations of a portion of the EVSE formed in accordance with an exemplary embodiment.

FIG. 7 is a fault detection circuit formed in accordance with an exemplary embodiment.

FIG. 8 is a fault detection circuit formed in accordance with an exemplary embodiment.

### DETAILED DESCRIPTION OF THE INVENTION

FIG. 1 illustrates electric vehicle supply equipment (EVSE) 100 formed in accordance with an exemplary embodiment. The EVSE 100 is configured to enable an electric vehicle 102 to be coupled to, or uncoupled from, a power supply 104. In operation, the EVSE 100 enables the electric vehicle 102 to be charged via power received from the power supply 104 when in the coupled configuration and to be electrically uncoupled from the power supply 104 in the uncoupled configuration.

The EVSE 100 generally includes a cable 110 having a first end 112 and an opposing second end 114. The EVSE 100 further includes a plug 120 that is coupled to the cable first end 112 and a nozzle 122 that is coupled to the cable second end 114.

The cable 110 includes a plurality of conductors 130 (shown in FIG. 2). For example, the cable 110 may include a power conductor 132, a neutral conductor 134, and a ground 136. In various embodiments, the conductors 130 are size fourteen American Wire Gauge (AWG 14) conductors that enable the cable 110 to supply up to sixteen amps (A) at a voltage of 110V and/or 220V to the electric vehicle 102. It should be realized that the cable 110 may include more than three conductors 130. Moreover, it should be realized that the wire sizes of the individual conductors 130 may be larger than 14 AWG. The cable 110 may also include various communication lines 140 (shown in FIG. 2) for transmitting information between the plug 120 and the nozzle 122 and/or electric vehicle 102. The communication lines 140 may include for example, a communication line 141 for transmitting a pilot signal 142, a communication line 143 for transmitting a proximity detection signal 144, and/or a communication line 145 for transmitting a nozzle temperature signal 146. The communication lines 140 may be for example, size AWG 20 to enable the pilot signal 142, the proximity detection signal 144, and the temperature signal 146 to be transmitted from the electric vehicle 102 to the plug 120 and/or transmitted from the plug 120 and received by the electric vehicle 102.

In operation, the proximity detection signal 144 is utilized to determine when the nozzle 122 is plugged into the electric vehicle 102. More specifically, when the nozzle 122 is initially coupled to the electric vehicle 102, the proximity detection signal 144 is generated. The pilot signal 142 provides information to the plug 120 that indicates that the electrical vehicle 102 is ready to initiate a charging operation. The pilot signal 142 also indicates a maximum current that may be supplied from the power supply 104 to the electric vehicle 102 during the charging operation. In various embodiments, a microcontroller unit (MCU) 200 determines that the nozzle 122 is plugged into the electric vehicle 102 and is ready to initiate the charging operation based on the inputs received from the pilot signal 142 and the proximity detection signal 144. The MCU 200 then outputs a relay control signal 148 to a relay 206 (shown in FIG. 2) when the inputs are received from the pilot signal 142 and the proximity detection signal 144.

Referring again to FIG. 1, the plug 120 may be embodied as a charging circuit interrupt device (CCID) 150 that is configured to connect the electric vehicle 102 to the power supply 104. In operation, the CCID 150 controls the current being transmitted from the power supply 104 to the electric vehicle 102 and thus controls the charging of the electric vehicle 102. The plug 120 also includes a connector 152 that enables the plug 120, and thus the electric vehicle 102, to be plugged into a standard AC power outlet 154 utilized in North America. The connector 152 is therefore configured to satisfy the criteria established by the National Electrical Manufacturer's Association (NEMA). For example, in one embodiment, the connector 152 is a (NEMA-5) plug.

The nozzle 122 is configured to couple to the electric vehicle 102 and therefore provides an electrical pathway between the power supply 104 and the electric vehicle 102. The nozzle 122 is configured to conform to the Society of Automotive Engineers (SAE) standard for electric vehicles. Accordingly, the nozzle 122 may be fabricated to conform to the SAE J1772 standard, for example.

FIG. 2 is a schematic illustration of the plug 120 shown in FIG. 1. In various embodiments, the plug 120 includes the MCU 200, a zero-crossing detector (ZCD) 202, an over current device (OCD) 204, and the relay 206 that together function to enable the electric vehicle 102 to be charged via the power supply 104, both shown in FIG. 1. The term “microcontroller” may include any processor-based or microprocessor-based computer including systems using reduced instruction set computers (RISC), application specific integrated circuits (ASICs), field programmable gate array (FPGAs), logic circuits, and any other circuit or processor capable of executing the functions described herein. The above examples are exemplary only, and are thus not intended to limit in any way the definition and/or meaning of the term “microcontroller”. The detailed explanation regarding the operation of the MCU 200, the ZCD 202, the OCD 204, and the relay 206 are explained in more detail below.

In general, the plug 120 may also include a protection device 210 for limiting the AC current and/or AC voltage supplied from the power supply 104 to the electric vehicle 102. The plug 120 also includes an isolated power supply 220 for providing power to the various operational components within the plug 120.

The plug 120 also includes a current filter/gain device 230 that is configured to generate a current signal 232 that is suitable for use by the MCU 200, the ZCD 202, and the OCD 204. For example, as described above, the current carried by the power conductor 132 may approach 16A. However, supplying a 16A signal to the MCU 200, the ZCD 202, and the OCD 204 may result in damage to one or all of these components. In operation, the current filter/gain device 230 is therefore configured to sense the current in the power conductor 132 and output the current signal 232, having a current level that is usable by the MCU 200, the ZCD 202, and the OCD 204. The plug 120 also includes a voltage attenuator device 240 that is configured to generate a voltage signal 242 that is suitable for use by the MCU 200, the ZCD 202, and the OCD 204. The voltage attenuator device 240 may measure voltage differences between the line and neutral and/or between the ground and neutral and/or between the ground and line. The relay 206 may be operated based on input from the voltage attenuator device 240. The voltage attenuator device 240 may measure voltage differences upstream and/or downstream of the relay 206.

The relay 206 is configured to operate in a closed state or an open state. In various embodiments, the relay 206 includes an electronic latch circuit 260, one or more coil drivers 262 and contacts 264. In the closed state, the contacts 264 are closed to enable power to be supplied from the power supply 104 to the electric vehicle 102. More specifically, the latch circuit 260 outputs a signal that energizes the coil driver(s) 262 causing the contacts 264 to close. Optionally, two coil drivers 262 are provided, including one coil driver 262 to drive the contacts 264 associated with the line and the neutral and the other coil driver 262 to drive the contact 264 associated with the ground. Having multiple coil drivers allows the contacts 264 to be driven independently. In other alternative embodiments, three coil drivers 262 may be provided one each for the line, neutral and ground. Alternatively, a single coil driver 262 may drive the line, neutral and ground. Moreover, the relay 206 is also configured to operate in an open state, e.g. the contacts 264 are opened to prohibit power from being supplied to the electric vehicle 102. More specifically, when the signal output from the latch circuit 260 is disabled or stopped, the coil driver 262 is de-energized causing the contacts 264 to open.

In operation, the relay 206 utilizes two signals to initiate a switching operation between the open state and the closed state, or between the closed state and the open state. The two signals include the relay control signal 148 provided by the MCU 200 and a ZCD output signal 250 provided by the ZCD 202.

In one embodiment, the relay control signal 148 may be generated based on a manual input from the operator. For example, when the operator desires to operate the relay 206 in the closed state, the operator may depress a button, or otherwise provide an indication to the MCU 200 to generate the relay control signal 148. The relay control signal 148 is then transmitted to the relay 206 to initiate a closure of the contacts 264. In another embodiment, the relay control signal 148 is automatically generated by the MCU 200 as described above. For example, the relay control signal 148 may be generated when the proximity detection signal 144 indicates that the electric vehicle 102 is connected to the power supply 104 and the pilot signal 142 is received at the MCU 200.

However, as described above, the contacts 264 in the relay 206 do not close or open unless two signals are received, e.g. the relay control signal 148 and the ZCD output signal 250 provided by the ZCD 202. Thus, although the MCU 200 may transmit the relay control signal 148 to the relay 206 to initiate opening or closing the contacts 264, the relay 206 does not physically open or close the contacts 264 until the ZCD output signal 250 is received from the ZCD 202.

FIG. 3 is a simplified block diagram of a portion of the EVSE 100 shown in FIG. 1. Accordingly, the EVSE 100 includes the CCID 150 and the nozzle 122. In various embodiments, the EVSE 100 also includes the capability to utilize the communication line 141 to transmit both the pilot signal 142 and additional information while ensuring that the nozzle 122 is still in compliance with the SAE J1772 standard. More specifically, the additional information is overlaid on the pilot signal 142. As a result, the pilot signal 142 provides the charging information required to conform to the SAE J1772 standard and also provides the additional information that is currently not available to the user. In various embodiments, the nozzle 122 therefore includes a nozzle control and display device (NCDD) 300 that is configured to receive the pilot signal 142 and utilize the pilot signal 142 to provide the additional information to the user as described in more detail below.

FIG. 4 is a detailed block diagram of a portion of the EVSE 100 shown in FIG. 3. In various embodiments, to overlay the additional information onto the pilot signal 142, the CCID 150 includes the MCU 200, a summer 310, and a switch 312. In various embodiments, the switch 312 may be implemented using a P-channel metal-oxide-semiconductor field-effect transistor (MOSFET). The NCDD 300 includes a DC/DC converter 320, a comparator 322, an MCU 324, a diode 326, and a resistor 328.

In operation, when the nozzle 122 is plugged into the electric vehicle 102, the proximity detection signal 144 is transmitted to the CCID 150 conveying information that the electric vehicle 102 is connected to the CCID 150 and in a standby mode waiting to initiate charging. Additionally, the pilot signal 142 conveys pilot information indicating the maximum current to be transmitted from the CCID 150 to the electric vehicle 102 during the charging mode. FIG. 5 is graphical illustration of the pilot signal 142 that may be generated, wherein the x-axis represents the time of the pilot signal 142 and the y-axis represents the amplitude of the pilot signal 142. In various embodiments, the pilot signal 142 is a pulse width modulated (PWM) signal that modulates between approximately +12V and approximately −12V. In various embodiments, when the nozzle 122 is plugged into the electric vehicle 102, the pilot signal 142 conveys the pilot information to the CCID 150 using only a positive portion 350 of the pilot signal 142 to convey pilot information 340. Accordingly, a negative portion 352 of the pilot signal 142 may be utilized to convey additional information 342. As a result, using the negative portion 352 of the pilot signal 142 enables the EVSE 100 to transmit the additional information 342 between the electric vehicle 102, the nozzle 122, and/or the plug 120 using the existing pilot signal 142 required by the J1772 standard. The additional information 342 may be alarm information, sensor information, or any other information that is desirable to transmit between the electric vehicle 102, the nozzle 122, and/or the CCID 150

In operation, and referring again to FIG. 4, to convey the additional information 342, the CCID 150 also includes a communication MCU 360 that is configured to monitor the pilot signal 142 and determine when the pilot signal 142 is conveying the pilot information 340. As discussed above, the pilot signal 142 conveys the pilot information 340 when the amplitude of the pilot signal 142 is positive and conveys the additional information 342 when the amplitude of the pilot signal 142 is negative. Accordingly, in operation, the communication MCU 360 is configured to determine when the amplitude of the pilot signal 142 is positive or negative to enable the additional information 342 to be conveyed without interfering with the pilot information 340.

The communication MCU 360 facilitates connection of the CCID 150 to the MCU 324 in the nozzle 122 to provide a full duplex communication network 362 that may send bi-directional information back and forth between the nozzle 122 and the CCID 150. For example, if the communication MCU 360 is transmitting a message to the nozzle 122, the MCU 324 operates in a standby mode to receive the message. Optionally, if the MCU 324 is transmitting a message to the communication MCU 360, the communication MCU 360 operates in a standby mode to receive the message.

More specifically, the switch 312 is configured to turn off when the pilot signal 142 has a positive amplitude to prohibit the additional information 342 from being transmitted. Optionally, the switch 312 is configured to turn on when the pilot signal 142 has a negative amplitude to enable the additional information 342 from being transmitted. Thus, the switch 312 controls the flow of information between MCU 200 and MCU 324 such that the transmission of the additional information 342 does not interfere with the positive side of the signal which is used for the pilot information 340.

In various embodiments, the pilot signal 142 may also provide power to the various components within the nozzle 122. For example, as shown in FIG. 4, the pilot signal 142 is input to the DC/DC converter 320 which converts the energy of the pilot signal 142 into a waveform that is suitable to provide power to the various components within the nozzle 122. Moreover, the diode 326 allows only the negative side 352 of the pilot signal 142 to flow to the MCU 324 via the comparator 322. Thus, the MCU 324 utilizes the negative side 352 of the pilot signal 142 to determine any changes in the voltage level of the pilot signal 142 that indicate whether the pilot information 340 is currently being transmitted and thus the additional information should not be transmitted or may be transmitted without interfering with the pilot information 340. As a result, each of the MCU 360 and the MCU 324 identify changes in the voltage level of the pilot signal 142. For example, if the pilot signal 142 is loaded, i.e. currently conveying pilot information 340, the voltage level of the pilot signal 142 may decrease from, for example, +12V to +11V.

Moreover, when the pilot signal 142 is loaded, i.e. currently conveying the additional information 342, the voltage level of the pilot signal 142 may increase from, for example, −12V to −11V. As a result, the CCID 150 continuously monitors both the negative and positive side of the pilot signal 142 and when the CCID 150 detects a voltage drop on the negative side of the pilot signal 150, the CCID 150 knows that a message is being transmitted. Additional information 342 may include latch and flashlight circuit 400, fault detection circuit 500, and fault detection circuit 600.

FIG. 6A is a schematic illustration of a portion of an exemplary latch and flashlight circuit 400 that may be installed within the nozzle 122. FIG. 6B is a schematic illustration of another portion of the exemplary latch and flashlight circuit 400. As shown in FIG. 6A, in various embodiments, the latch and flashlight circuit 400 receives power from the pilot signal 142. The latch and flashlight circuit 400 includes a diode D1, a diode D2, a diode D12, and a diode D13 that together form a full bridge rectifier 410 that modifies the pilot signal 142 to a voltage and/or current level that is suitable for use by the latch and flashlight circuit 400. More specifically, the full bridge rectifier 410 takes the bipolar pilot signal 142 and outputs a DC signal that is the power source for the flashlight and latch circuit 400.

Referring to FIG. 6B, a diode D14 performs half wave rectification to provide a suitable power source for various components that are not capable of utilizing the output supplied from the full bridge rectifier 410. In operation, the portion of the circuit electrically downstream from the diode D14 performs three functions. Initially, the latch and flashlight circuit 400 includes a magnetic sensor U1 that senses a magnetic field of a latch of the nozzle 122 has been depressed. In operation, the latch is depressed by the operator when coupling and/or uncoupling the nozzle 122 from the electric vehicle 102. In operation, when the latch is depressed, the magnetic sensor U1 activates a pair of MOSFETs Q3 and Q5 activating a visible light, referred to herein as a flashlight 432 that is installed on the nozzle 122. More specifically, once the nozzle latch is pressed down, the flashlight 432 is activated to provide the operator with a visual indication that the nozzle 122 is being coupled or uncoupled from the electric vehicle 102. In various embodiments, the flashlight may illuminate continuously or may illuminate cyclically between being illuminated and un-illuminated.

The latch and flashlight circuit 400 provides a termination point for the proximity detection signal 144. More specifically, a resistor R8 and a resistor R11 are utilized as the standard termination resistances required by the J1772 standard. In operation, when the nozzle 122 is plugged into the electric vehicle 102, a current is transmitted through the resistors R8 and R11 with one condition, wherein R11 is dependent on the switch Q6. For example, if the switch Q6 is on, the resistor R11 is shorted out to provide an indication that the latch is being pressed or not pressed. In one embodiment, if the latch is being depressed, no charging current is provided to the electric vehicle 102. Optionally, if the latch is not depressed, charging current is supplied to the electric vehicle 102. Thus, the magnetic sensor U1 facilitates prohibiting the charging current from being supplied to the electric vehicle 102 when the latch is depressed, and thus reduces and/or eliminates any intermittent electrical arcs that may occur if the operator attempts to uncouple the nozzle 122 when the charging current is being supplied to the electric vehicle. Thus, the magnetic sensor U1 functions as an active switch that may be activated using the pilot signal 142. Moreover, the magnetic sensor U1 turns on an off based on the presence or absence of a magnetic field.

FIG. 7 is a schematic illustration of an exemplary fault detection circuit 500 that may be utilized to determine whether the pilot signal 142 is positive and therefore conveying the pilot information 340 or negative and therefore capable of transmitting the additional information 342. For example, assume that the pilot signal 142 is negative. In this case, the current is transmitted through a diode D11 and C6 charges to approximately −12V. As a result, the voltage at J15 is also approximately −12V which is an indication of a fault and an LED 502 is illuminated. However, if the pilot signal 142 is positive, the current is transmitted through a diode D10 and the LED 502 is not illuminated. For example, if the pilot signal 142 is approximately +12V, D10 is on and D11 is off Accordingly, C6 and J15 will each be at approximately +12V indicating that there is no fault and enable the flashlight 432 to illuminate when the latch is depressed. Optionally, if the pilot signal 142 becomes bipolar, i.e. the pilot signal 142 begins to modulate between a positive voltage and a negative voltage, the voltage across C6 will be approximately zero and the LED 502 turns on. In operation, the fault detection circuit 500 therefore functions as a state detector to determine if the pilot signal is +12V, −12V, or a PWM.

More specifically, at J15, which is the voltage across C6, when the pilot signal 142 voltage is 0V or +12V, i.e. a fault sense, Q7 turns on to activate the LED 502 indicating that there is no fault detected. However, when the voltage of the pilot signal 142 is negative Q7 turns off, the flow of current through the LED 502 stops, Q9 now turns on, and the flow of current goes through the a second LED 504 indicating a fault condition. In various embodiments, a color of the first LED 502 may be different than a color of the second LED 504. For example, the first LED 502 may be green to indicate no fault condition is detected and the second LED 504 may be red indicating a fault condition is detected. In general, the circuit 500 therefore extracts energy from the full bridge rectifier 410 and utilizes the extracted energy to provide a fault or no fault indication to the operator.

FIG. 8 is a schematic illustration of an exemplary fault detection circuit 600 that may be utilized to stop charging using sensors/sensing at the nozzle 122. An MCU 620 is provided at the nozzle 122. The MCU 602 is connected to the communication line 141 (shown in FIG. 2) for transmitting along the pilot signal 142 and the communication line 143 (shown in FIG. 2) for transmitting along the proximity detection signal 144.

In an exemplary embodiment, the MCU 602 receives a latch press detection signal from a latch detection sensor 604. For example, the latch detection sensor 604 may be a magnetic sensor associated with the latch that senses a magnetic field of the latch to detect when the latch has been depressed. In operation, the latch is depressed by the operator when coupling and/or uncoupling the nozzle 122 from the electric vehicle 102. In operation, when the latch is depressed, the latch detection sensor 604 causes the MCU 602 to activate a pair of switches Q10 and Q11 that shorts the pilot signal 142 to ground. The plug 120 (shown in FIG. 2) senses the pilot signal at 0V and will stop charging, disconnecting the power supply to the electric vehicle 102. Such a system controls power supply using control and intelligence at the nozzle 122. Such a system eliminates the risk of arcing or sparking when the nozzle is disconnected from the car. For example, in systems that do not include the fault detection circuit 600, situations may occur where the latch may be pressed and released too quickly such that charging will be restarted because the nozzle 122 is still in close proximity to the electric vehicle 102. As the nozzle 122 is removed from the electric vehicle 102, arcing or sparking may occur, which may damage the nozzle 122, the electric vehicle 102 or may harm the operator. The fault detection circuit 600 eliminates such risk by causing the pilot signal 142 to short to ground, causing the plug 120 to stop the charging operation based on latch press detection.

In an exemplary embodiment, the MCU 602 receives a temperature signal from a temperature sensor 606, which may be sense a temperature of the nozzle 122 or components of the nozzle 122. When the temperature exceeds a threshold, the MCU 602 activates the MOSFETs Q10 and Q11 to short the pilot signal 142 to ground. The plug 120 senses the pilot signal at 0V and will stop charging, disconnecting the power supply to the electric vehicle 102. Such a system controls power supply using control and intelligence at the nozzle 122.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

What is claimed is:

1. An electric vehicle support equipment (EVSE) system comprising:
a nozzle configured to couple to an electric vehicle, the nozzle including a first microcontroller (MCU);
a charging circuit interrupt device (CCID) configured to couple to a power source, the CCID including a second MCU;
a cable coupled between the CCID and the nozzle, the CCID configured to
receive a pilot signal from the electric vehicle, the pilot signal conveying pilot information; and
overlay additional information onto the pilot signal.

2. The EVSE of claim 1, wherein the first MCU and the second MCU form a full-duplex communication network.

3. The EVSE of claim 1, wherein the pilot information and the additional information are transmitted on a single communication line.

4. The EVSE of claim 1, wherein the first MCU and the second MCU are each configured to:
transmit the pilot information when the pilot signal is positive; and
transmit the additional information when the pilot signal is negative.

5. The EVS of claim 1, wherein the CCID further includes a communication MCU to determine when the pilot signal is positive or negative.

6. The EVSE of claim 1, wherein the pilot signal provides power to the second MCU.

7. The EVSE of claim 1, wherein the nozzle includes a DC/DC converter configured to receive power from the pilot signal and provide power to the first MCU

8. The EVSE of claim 1, wherein the nozzle includes a latch and flashlight circuit that is powered by the pilot signal.

9. The EVSE of claim 8, wherein the latch and flashlight circuit includes a full bridge rectifier configured to receive the pilot signal and outputs a DC signal that is the power source for the flashlight and latch circuit.

10. The EVSE of claim 1, wherein the nozzle further comprises a magnetic sensor (U1) configured to sense a magnetic field of a nozzle latch and output a visual indication when the latch is depressed.

11. The EVSE of claim 10, wherein the nozzle further comprises a magnetic sensor (U1) configured to activate a flashlight when the nozzle latch is depressed.

12. The EVSE of claim 10, wherein the first MCU is configured to activate at least one switch to short the pilot signal to ground when the latch is depressed.

13. The EVSE of claim 1, wherein the nozzle further comprises a magnetic sensor (U1) configured to activate a flashlight when the nozzle latch is depressed.

14. The EVSE of claim 13, wherein the flashlight is installed in the nozzle and receives power from the pilot signal.

15. The EVSE of claim 1, wherein the nozzle further comprises a fault detection circuit configured to determine if the pilot signal is approximately positive twelve volts, negative twelve volts, or operating as a pulse width modulated (PWM) signal.

16. A nozzle for coupling an electric vehicle to a power source, the nozzle comprising:
a microcontroller (MCU) configured to
receive a pilot signal (142) from the electric vehicle, the pilot signal conveying pilot information; and
overlay additional information onto the pilot signal.

17. The nozzle of claim 15, wherein the MCU is configured to form a form a full-duplex communication network with a second MCU installed in a charging circuit interrupt device (CCID).

18. The nozzle of claim 15, wherein the pilot signal provides power to the MCU

19. The nozzle of claim 15, further comprising a latch and flashlight circuit that is powered by the pilot signal.

20. The nozzle of claim 15, further comprising a fault detection circuit configured to determine if the pilot signal is approximately positive twelve volts, negative twelve volts, or operating as a pulse width modulated (PWM) signal.
